(19) United States
(12) Patent Application Publication
(10) Pub. No.: US 2022/0385480 A1
(43) Pub. Date: Dec. 1, 2022

(54) DEVICE REGISTRATION

(71) Applicant: Hewlett-Packard Development Company, L.P., Spring, TX (US)

(72) Inventors: Thalia Laing, Bristol (GB); Joshua Serratelli Schiffman, Bristol (GB); Mark Ryan, Bristol (GB)

(21) Appl. No.: 17/755,889

(22) PCT Filed: Dec. 20, 2019
(86) PCT No.: PCT/US2019/067930

§ 371 Date: May 11, 2022

(51) Int. Cl. H04L 9/32

(52) U.S. Cl. CPC H04L 9/3255; H04L 9/3273

(57) ABSTRACT

In an example there is provided a method for a set of registered devices that are registered to participate in an authentication protocol, where each registered device has a share of an authentication key. The method comprises generating share data for a share of the authentication key. The share data is communicated from an authorised subset of the registered devices to a device. The share of the authentication key is generated at the device, on the basis of the share data. The share of the authentication key combines with shares of the registered devices to allow the device to participate in the authentication protocol.

### BACKGROUND

Authentication systems are used in a wide variety of scenarios to verify the identity of an entity. These systems may use an authentication factor such as a device or a password as part of an authentication process. In some systems, multiple devices participate to authenticate a user or transaction. A user may demonstrate possession of a number of devices when prompted by the authentication system. The authentication system verifies the user or transaction, based on the devices that are presented by the user. In particular, if a user presents an authorised subset of devices the user or transaction is authenticated.

### BRIEF DESCRIPTION OF THE DRAWINGS

FIG. 1 is a schematic diagram showing an authentication system, according to an example.

FIG. 2 is a schematic diagram showing an authentication system, according to an example.

FIG. 3 is a schematic diagram showing an authentication system, according to an example.

FIG. 4 is a block diagram showing a method of registering a device in a group of devices.

FIG. 5 shows a processor associated with a memory comprising instructions for

[symbol]

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Authentication systems are widely deployed systems which are used in a variety of different contexts. In modern computing environments authentication systems are used to establish the identity of a user. Once a user's identity has been established, they may be able to gain access to services or data on the computing system or over network, for example. Authentication systems are also used in payment systems, for example, to verify transactions.

A user may be prompted by the authentication system to present an authentication factor. For example, in some systems a user may be asked to demonstrate possession of an identification card. Alternatively, a user may be prompted to enter a password.

In some authentication systems a user demonstrates that they have a device in their possession as part of an authentication protocol. A device, unlike a human, can store a cryptographically secure password and can use public key cryptography. When the user wants to authenticate, an authenticating party sends the device a challenge. The challenge is signed by the device using the private key corresponding to a previously enrolled public key. A valid signature shows the authenticating party that someone with access to the device wants to authenticate. In this case, possession of the authentication factor can be demonstrated without revealing secure information to the authenticating party relating to the authentication factor.

In some authentication systems, an authentication factor is distributed across multiple devices. When the user is prompted to authenticate themselves or a transaction as part of an authentication protocol, they demonstrate possession of a subset of devices across which the authentication factor is distributed. If the combined information from the subset of devices is sufficient to demonstrate possession of the authentication factor, then the user or transaction is authenticated. In these systems, different subsets of devices may be presentable to demonstrate possession of the authentication factor. Such subsets are referred to herein as authorised subsets of devices.

The methods and systems described herein may be used to provision a share of an authentication token such as a cryptographic signing key. Herein a share is the information a device stores corresponding to the authentication token. The resultant share that the device possesses may be combined with shares of already registered devices. This allows the device to participate with the other registered devices in the authentication protocol.

The methods and systems described herein do not use a trusted dealer to be online after the initial distribution of shares to the registered devices. Furthermore, the methods do not utilise a full re-provisioning of shares each time a new device joins the group. A full re-provisioning of shares uses a trusted dealer. Moreover, previously registered devices need to be online, in addition to the new device, at the time the new shares are provisioned.

The methods described herein also provide auditing of registrations of devices. In examples an audit log of provisioning of the shares to new devices is maintained. This prevents the provisioning of the same share multiple times.

Threshold cryptographic techniques may be used to distribute an authentication factor among multiple devices. In a threshold scheme, a trusted dealer distributes shares of a signing key across multiple user-owned devices. An authorised subset of devices comprises any subset of devices greater than or equal to a threshold. Any authorised subset can combine partial signatures that are generated with the share of the signing key, which they possess, to produce a full signature on an authentication challenge.

According to examples described herein, starting from a (t, n) threshold scheme, that is a scheme for n devices with a threshold of t, when a new device enters the system, the parameters of the scheme become (t, n+1). In particular, the threshold does not change, but the number of devices is increased.

In order to increase the threshold, the system would need to be re-provisioned. In the examples described herein group public keys remain the same when new devices are introduced, and the shares stored by devices that are already in the group also remain the same, In particular, there is no re-provisioning of shares.

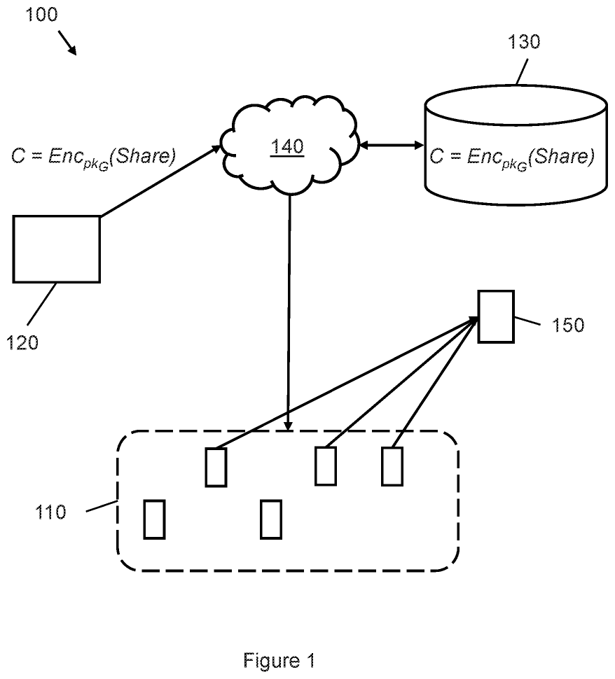

FIG. 1 is a schematic diagram showing an authentication system 100 according to an example. The system 100 shown in FIG. 1 may be used in conjunction with the methods described herein.

The system 100 comprises a group of devices 110. Each device 110 may be a physical device such as smart cards, smart phones, watches, laptops or personal computers, or other kinds of computing devices. In examples, the devices 110 can store data securely and are capable of communication with each other. In FIG. 1, the devices 110 belong to a user who wishes to authenticate themselves or a transaction.

In FIG. 1, there is shown a dealer or distributor 120. The dealer 120 is a trusted logical entity, such as a computing device, that is arranged to distribute data to the group of devices 110. In particular, the dealer 120 is assumed to be in communication with the devices 110 in an initial set up phase, to distribute shares of a secret authentication key. For example, the dealer 120 may distribute shares of signing key using a threshold signature scheme.

In FIG. 1 the dealer 120 is shown as being a separate entity from the devices 110. In examples described herein the dealer may be one of the devices 110 that are registered to participate in authentication. According to other examples, the dealer 120 is implemented by a trusted third-party entity.

When the user is prompted to authenticate themselves or a transaction, they may present an authorised subset of devices 110. For example, in the case where the system 100 implements a threshold signature scheme, the devices 110 can authenticate by generating partial signatures on a challenge received from an authentication system (not shown in FIG. 1). According to examples described herein, the partial signatures of the devices are combined to generate a full signature on the challenge. Generation and combination of partial signatures may also be performed together by devices in a distributed manner.

In FIG. 1, the devices 110 and dealer 120 are also in communication with a networked storage device 130. The devices 110 and dealer 120 are arranged to communicate with the storage device 130 through a remote network 140. During the initial set up phase, the dealer 120 is arranged to generate a further share of the authentication key. This over-provisioned share is generated at the same time as the shares which are held by the devices 110.

This over-provisioned share may be used in the same way as the other shares. In particular, in the case where the shares are shares of a signing key, the additional share may also be used to generate a partial signature. This partial signature may be combined with partial signatures generated with the other shares of the signing key, to generate a full signature.

In FIG. 1, the over-provisioned share is encrypted using a group public key pk_{G} associated to the devices 110. The encrypted share is communicated to the networked storage device 130, via the network 140, by the dealer 120 during the setup phase. A ciphertext C of the encrypted share is stored in the storage device 130.

In FIG. 1, the user wishes to add a further device 150 to the group of registered devices 110. The device 150 is outside of the group of devices 110 initially and does not possess a share of the authentication key.

When the further device 150 is introduced, the user may be alerted to the presence of the further device 150 on one of their other devices 110. For example, if one of the devices 110 has a graphical user interface, the user may be prompted that a new device has been detected, and asked to confirm that they are aware that the further device is trying to register in the group 110.

Once confirmed by the user, the device 150 is authorised by the devices 110 and secure channels are established with the devices 110 in the group.

In the next phase, an authorised subset of the devices 110 obtain the ciphertext C from the networked storage device 130, via the network 140.

The authorised subset of devices 110 decrypt a copy of the ciphertext using a share skᵢ of a distributed secret key sk, corresponding to the group public key pk_{G}. These shares may also have been distributed by the dealer 110 during the setup phase. Each member of the authorised subset then holds a partial decryption of the over-provisioned share.

In the next phase, the devices 110 in the authorised subset communicate their partially decrypted over-provisioned share to the device 150 via the previously established secure channels. The device 150 combines the partial decryptions to recover the full share. Combining the partial decryptions results in the full share since the subset of devices which communicated the partial decryptions is an authorised subset.

Once the further device 150 obtains its own share of the authentication key, it may also participate in an authentication protocol. According to examples described herein, the further device 150 may also participate with the other devices 110 to add further devices to the group 110. The total number of devices which may be added to the group depends on how many shares are over-provisioned by the dealer 120.

In examples described herein, when each device 110 computes the partial decryption, a confirmation or a ‘receipt’ may be sent to the network 140 to a network storage administrator (not shown in FIG. 1). When the device 150 computes the share, it may also send a receipt of the share to the network admin. The receipts may be generated using cryptographically secure protocols. For example, a proof of ownership may be used to demonstrate ownership of a share.

According to examples, when the network admin is sure the share has been received and can be used, the ciphertext corresponding to the over-provisioned share in the networked storage device 130 is deleted. This ensures that the same ciphertext is not sent multiple times to the devices 110 and, in particular, that the over-provisioned shares are used once.

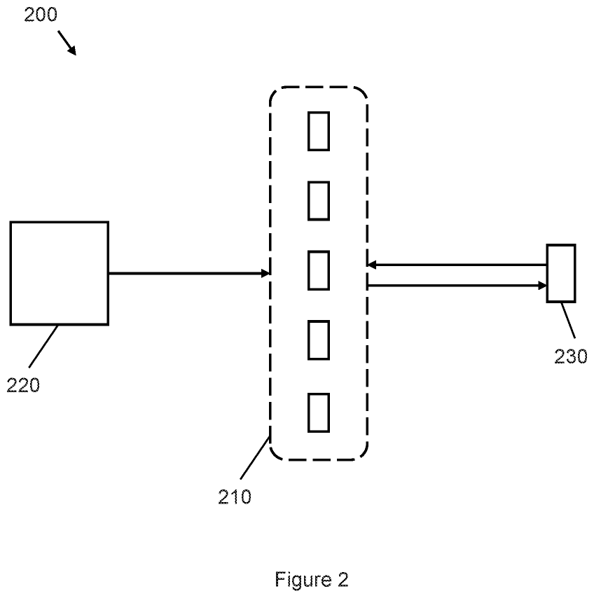

FIG. 2 is a schematic diagram showing a further authentication system 200 according to an example. The system 200 shown in FIG. 2 may be used in conjunction with the methods described herein.

The authentication system 200 comprises a group of devices 210 in the ownership of a user, similar to the authentication system 100 shown in FIG. 1. Each of the devices 210 may be a physical device such as smart cards, smart phones, watches, laptops or personal computers, or other kinds of computing devices. The devices 210 can also store data securely and are capable of communication with each other.

In FIG. 2, there is also shown a dealer or distributor 220. The dealer 220 is assumed to be in communication with the devices 210 in an initial set up phase, to distribute shares of an authentication key. The dealer 210 may also be a separate trusted entity or one of the devices 210.

The devices 210 are arranged to participate in an authentication protocol. For example, where the system 200 implements a threshold signature scheme, an authorised subset of the devices 210 generate partial signatures using a share of a secret signing key. The partial signatures may be combined to generate a full cryptographic signature.

In the system 200, during an initial set up phase, rather than generating a ciphertext using a group public encryption key, the dealer 220 is arranged to generate sub-shares of over-provisioned shares. Sub-shares may also be generated using a threshold secret sharing scheme. The sub-shares are distributed to the devices 210 in the setup phase. The devices 210 do not therefore access a ciphertext from a networked storage device.

The sub-shares of an over-provisioned share, which are held by an authorised subset of the devices 210, may be combined to recover the over-provisioned share. The over-provisioned share may be used in the same way as the other shares of the authentication key. For example, an over-provisioned share of a signing key may also be used to generate a partial signature. This partial signature combines with partial signatures generated with the other shares of the signing key, to generate a full signature.

In FIG. 2, a new device 230 attempts to participate with the other devices 210. The further device 230 is initially outside of the group of devices 210 and does not possess a share. The user may introduce the further device 230 themselves. The user may also be prompted to give authorisation on one of their other devices 210. In a manner similar to the device 150 in FIG. 1, the further device 230 is authorised by the devices 210 and secure channels are established with the devices 210 in the group.

In examples described herein, an authorised subset of the devices 210 communicate their sub-shares of the over-provisioned share, via the secure channels previously established, to the further device 230. The further device 230 then combines the sub-shares to recover the over-provisioned share. The further device 230 then participates in authentication in the same way as the other devices 210.

In the case where multiple shares are over-provisioned to allow a plurality of new devices to join the group of devices 210, each device 210 stores a counter. The counter indicates which share to send to the new device to allow the new device to join the group. A protocol is used to establish the highest counter among the authorised subgroup of the devices 210 that help the new device. For example, in one case each device in the subgroup broadcasts the highest value corresponding to the sub-share that they previously communicated to a new device. The highest value determines which share to communicate to the next new device that wishes to join the group 210. All the devices in the authorised sub-group identify the highest counter, update their counters to that value, and send that appropriate sub-share to the new device.

According to examples, the same over-provisioned share may end up being used twice by two different disjoint authorised subsets. If a threshold secret sharing scheme is used, this will not happen if the threshold is higher than half of the total number of devices. However, if the threshold is lower than half of the total number of devices then the counter for two distinct authorised subsets may not be synced. According to examples described herein a global clock may also be established to ensure that the highest value established by a subset corresponds to the highest value established by any other subset.

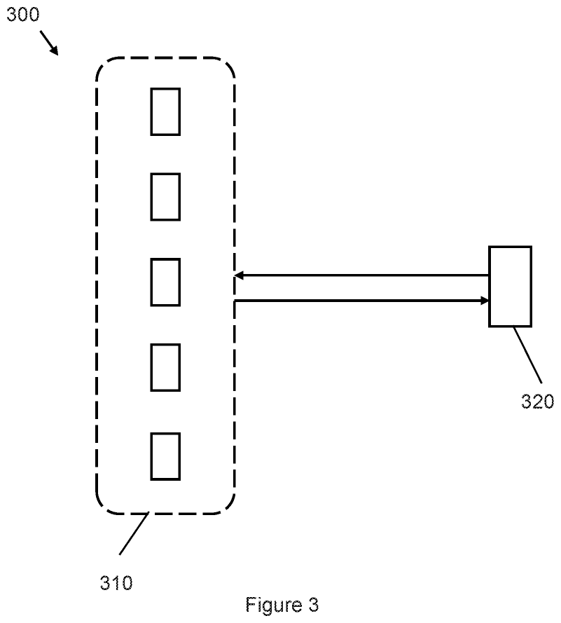

FIG. 3 is a schematic diagram showing an authentication system 300 according to an example. The authentication system 300 shown in FIG. 3 may be used to in conjunction with the methods described herein.

Similarly to the authentication systems 100 and 200 shown in FIGS. 1 and 2 the system 300 comprises a group of devices 310. The devices 310 can store data securely and may communicate with each other.

According to examples, similarly to the systems 100 and 200, a dealer (not shown in FIG. 3) is present during an initial set up phase. The dealer distributes shares to the devices 310 in a manner similar to the dealers shown in FIGS. 1 and 2. However, unlike the systems 100 and 200 shown in FIGS. 1 and 2, the dealer does not over-provision shares to the devices 310 to accommodate further devices.

According to examples described herein, the devices 310 are arranged to execute a repairable secret sharing protocol. A repairable secret sharing protocol may allow the recovery or repairability of a share, for one or more devices. An authorised subset of the existing devices may collaborate to recover the share by communicating appropriate share data between themselves.

A repairable secret sharing scheme may also be used for a new device. Rather than recovering a share, the existing devices extend the sharing of a secret by communicating share data to the new device. The new device can combine the share data to recover the share, according to the particular repairable protocol which is used.

In FIG. 3, a further device 320 wishes to participate in the authentication protocol. As in the previous setups, the device 320 is outside of the group of devices 310 initially and does not possess a share of the authentication key.

When the further device 320 is introduced, the user may be alerted to the presence of the further device 320 on devices 310. Once confirmed by the user, the device 320 is authorised by the devices 310 and secure channels are established with the devices 310 in the group.

According to examples, an authorised subgroup of the devices 310 may use a repairable protocol to communicate share data to the further device 320. The further device 320 follows the repairable secret sharing protocol to recover the share of the authentication key. The device 320 may then participate in a manner similar to the other devices 310.

In examples, each device 310 also stores a counter. At the start of the reparable protocol, the devices 310 all adopt the highest counter of the devices in the participating authorised subset which aid the new device to construct a share. Each time a new device is introduced the counter is incremented.

Similarly to the counters stored by the devices 210 in FIG. 2, an issue may arise in the case where the distributed secret sharing scheme allows for disjoint authorised subgroups of devices, since the counters of these group may fall out of sync. This can also be resolved using a global clock.

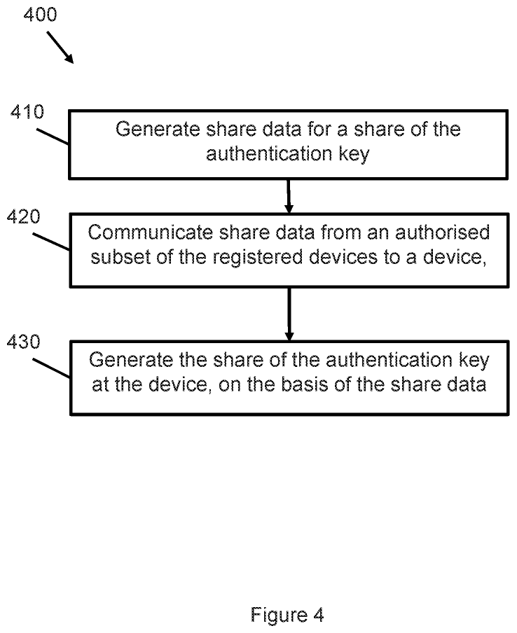

FIG. 4 is a block diagram showing a method 400 of registering a device according to an example. The method 400 shown in FIG. 4 may be used in conjunction with the systems shown in FIGS. 1-3.

The method 400 is implemented on a set of devices such as devices 110, that are registered to participate in an authentication protocol. Each registered device is assumed to have a share of an authentication key which may be associated to the user. Such a share may be distributed to the devices in advance, using a trusted dealer, in the manner previously described. For example, the shares may be generated and distributed by a trusted dealer implementing a threshold secret sharing scheme.

At block 410, share data for a share of the authentication key is generated. In one case, generating share data for a share of the authentication key comprises accessing an encryption of a share of the authentication key and partially decrypting the share, at each registered device. In a further example, generating share data, comprises generating sub-shares of a share of the authentication key and distributing the sub-shares to the registered devices.

In one case, share data is generated by forming a further share of the authentication key on the basis of inter-device communication between the registered devices, in response to the request to register the device. The further share may be generated using a repairable secret sharing scheme. Each registered device possesses share data, that may be communicated to a new device to recover the further share.

At block 420, share data from an authorised subset of the registered devices is communicated to a device. In examples, the share data is communicated in response to a request from a device to participate in the authentication protocol. In some cases, block 420 is implemented in response to an authorisation at a user interface to register the device.

At block 430 the share of the authentication key is generated at the device, on the basis of the share data. In examples, generating the share from the share data comprises executing a combining procedure using a secret sharing protocol, on the basis of the share data received from the authorised subset of the devices.

In one case, the device combines partial decryptions of a ciphertext to decrypt the full ciphertext and recover the overprovisioned share. In a second example, the device combines sub-shares of an overprovisioned share, according to a secret sharing protocol. In a third example, the device executes a repairable secret sharing protocol to recover the further share.

The share of the authentication key combines with shares of the registered devices to allow the device to participate in the authentication protocol.

In some cases, the method 400 further comprises, at each registered device, accessing a counter indicating the share of the authentication key to be distributed to the device. This may further comprise incrementing the counter at each device, in response to communicating share data from an authorised subset of the registered devices.

The methods and systems described herein improve the usability of multidevice based authentication systems by relaxing the infrastructure for managing devices and giving flexibility for adding devices. This applies even in the case where some of the previously registered devices are no longer online.

Users frequently change devices. They may wish to add a new device but do not want to have to log onto every device in order to re-provision keys and share data. The methods and systems described herein make the process more efficient and smoother for the user by adding the device to the system while keeping information such as the public key and the data on existing devices,

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

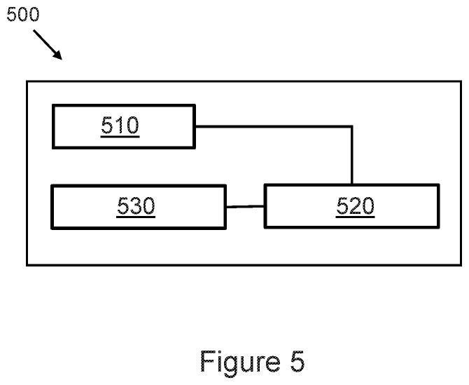

For example, the instructions may be provided on a non-transitory computer readable storage medium encoded with instructions, executable by a processor. FIG. 5 shows an example of a processor 510 associated with a memory 520. The memory 520 comprises computer readable instructions 530 which are executable by the processor 510.

The instructions 530 communicate a request to register a device in a group of registered devices, each registered device having a share of the authentication token; obtain share data, at the device, corresponding to a share of an authentication token, the share data being obtained from an authorised subset of registered devices and generate the share of the authentication token, on the basis of the share data, wherein the share of the authentication token combines with shares of the registered devices to allow the device to participate in an authentication protocol.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for a set of registered devices that are registered to participate in an authentication protocol, each registered device having a share of an authentication key, the method comprising:
generating share data for a share of the authentication key;
communicating share data from an authorised subset of the registered devices to a device; and
generating the share of the authentication key at the device, on the basis of the share data,
wherein the share of the authentication key combines with shares of the registered devices to allow the device to participate in the authentication protocol.

2. The method of claim 1, wherein generating share data for a share of the authentication key comprises accessing an encryption of a share of the authentication key and partially decrypting the share, at each registered device.

3. The method of claim 1, wherein generating share data, comprises generating sub-shares of a share of the authentication key and distributing the sub-shares to the registered devices.

4. The method of claim 1, wherein generating share data comprises forming a further share of the authentication key on the basis of inter-device communication between the registered devices, in response to a request to register the device.

5. The method of claim 4, wherein forming the further share of the authentication key is performed using a repairable secret sharing scheme.

6. The method of claim 1, comprising authorising the request to register the device at a user interface.

7. The method of claim 1, comprising receiving a request from a second device, and communicating share data from an authorised subset of the registered devices including the first device.

8. The method of claim 1, comprising, at each registered device, accessing a counter indicating the share of the authentication key to be distributed to the device.

9. The method of claim 8, comprising incrementing the counter at each device, in response to communicating share data from an authorised subset of the registered devices.

10. An apparatus, comprising:
a plurality of registered devices to participate in an authentication protocol,
a share distributor, to distribute shares of an authentication key, to the plurality of registered devices,
wherein, in response to a request to participate in the authentication protocol, an authorised subset of the plurality of registered devices communicates share data for a share of the authentication key to a device in communication with the plurality of registered devices, whereby the further device participates in the authentication protocol.

11. The apparatus of claim 10, wherein the plurality of registered devices generates share data for the share of the authentication key.

12. The apparatus of claim 10, wherein the share data comprises partial decryptions of the share, generated by the plurality of registered devices.

13. The apparatus of claim 10, wherein the share data comprises sub-shares of the share of the authentication key generated by the share distributor.

14. The apparatus of claim 10, wherein the set of authorised subsets are determined according to an access structure.

15. A non-transitory machine-readable storage medium encoded with instructions executable by a processor to:
communicate a request to register a device in a group of registered devices, each registered device having a share of an authentication token
obtain share data, at the device, corresponding to a share of the authentication token, the share data being obtained from an authorised subset of registered devices; and
generate the share of the authentication token, on the basis of the share data, wherein the share of the authentication token combines with shares of the registered devices to allow the device to participate in an authentication protocol.
